(19) United States
(12) Patent Application Publication
(10) Pub. No.: US 2015/0258670 A1
(43) Pub. Date: Sep. 17, 2015

(54) WRENCH'S BOLT HEAD LOCATOR STRUCTURE

(71) Applicant: YEO-MING WANG, Taipei City (TW)

(72) Inventor: YEO-MING WANG, Taipei City (TW)

(21) Appl. No.: 14/209,224

(22) Filed: Mar. 13, 2014

(51) Int. Cl. B25B 23/00; B25B 23/08; B25B 23/18

(52) U.S. Cl. CPC B25B 23/0071; B25B 23/18; B25B 23/08

(57) ABSTRACT

A wrench comprises a head part, in which an accommodation space is developed and a shank part; an actuator device comprising at least a locating piece situated at the wrench and extending into the accommodation space. As such, the wrench's bolt head locator structure which securely fix a bolt head in a wrench, prevents malposition between the wrench and the bolt head, and realizes smooth, convenient and safe operation of the wrench; the wrench's bolt head locator structure in which conjunction planes between a wrench and a bolt head are properly illuminated facilitates safe visual inspection in an operating area and promotional practicability and product competitiveness.

### BACKGROUND

1. Field of the Invention

The present disclosure relates to a ratchet wrench structure, particularly a wrench's bolt head locator structure which is conveniently assembled and in favor of economic effect in manufacture.

2. Descriptions of the Related Art

The wrenches which are common hand tools used in screwing in or out bolts or nuts are classified into various types such as open spanners, combo wrenches, box spanners, adjustable wrenches and socket wrenches. A conventional wrench structure comprises a head part and a shank part: the head part develops an accommodation space in which a bolt or a bolt head is held; the shank part is an area on which a twisting force is applied for screwing in or out a bolt head when the bolt head is thoroughly held in the accommodation space.

A conventional wrench which can be rotated clockwise or counterclockwise to screw in or out a bolt head technically and save effort still has some drawbacks. For example, a wrench's head part subject to limited space or angles for force application is usually separated from a bolt head securely fixed in the wrench's accommodation space and needs to fix the bolt head in the accommodation space strenuously; the repeated action may damage the bolt head in case of malposition between the head part (accommodation space) and the bolt head on which a strong or improper force is applied. As a result, a conventional wrench which evolves in malposition between a wrench and a bolt head is not an ideal design due to a valid solution not existing in a conventional wrench structure. Accordingly, how to prevent drawbacks in operating a conventional wrench is an important topic deserving to be overcome by the person skilled in the art.

Having considered disadvantages in use and unideal structural design of a conventional wrench, the inventor designed a wrench's bolt head locator structure as one solution in favor of convenient, stable and safe operation for the general public and development of the industry.

### SUMMARY OF THE INVENTION

The object of the present disclosure is to provide a wrench's bolt head locator structure which relies on simple components and operation to securely fix a bolt head in a wrench, prevents malposition between the wrench and a bolt head, and realizes smooth, convenient and safe operation of the wrench.

The other object of the present disclosure is to provide a wrench's bolt head locator structure in which conjunction planes between a wrench and a bolt head are properly illuminated for safe visual inspection in an operating area and promotional practicability and product competitiveness.

The technical measures in the wrench's bolt head locator structure for the above purposes are: a wrench comprising a head part in which an accommodation space is developed and a shank part; an actuator device comprising at least a locating piece situated at the wrench and extending into the accommodation space.

In the wrench's bolt head locator structure, the accommodation space is an open space, an encompassed space, or another specific space.

In the wrench's bolt head locator structure, the locating piece is immovably or flexibly held in the wrench.

In the wrench's bolt head locator structure, the locating piece is fixed on the wrench via riveting, screw joint, pivoting or another method.

In the wrench's bolt head locator structure, the accommodation space is encircled by a plurality of conjunction planes, all of which can be flat planes, camber surfaces or curved surfaces or a mixture thereof

In the wrench's bolt head locator structure, the locating piece is a sheet body made of metal or plastic material.

In the wrench's bolt head locator structure, the locating piece is a magnetic metal sheet.

In the wrench's bolt head locator structure, the head part is provided with the locating pieces at its both lateral sides.

In the wrench's bolt head locator structure, the locating piece has an actuation groove by which a guide pin can be held in the head part via riveting, screw joint, pivoting or another method.

In the wrench's bolt head locator structure, the wrench is further provided with a lighting device which can be LED lighting at a proper location or around the accommodation space.

In the wrench's bolt head locator structure, the wrench further comprises recessed surfaces which are located at and lower than lateral sides of the wrench for setup of the locating piece and expand from the accommodation space to cover at least the locating piece around.

For technical features and effects in terms of the present disclosure completely comprehended and recognized, the preferred embodiments and accompanying drawings are thoroughly described hereinafter.

### BRIEF DESCRIPTION OF THE DRAWINGS

FIG. 1 is a perspective view illustrating a wrench's bolt head locator structure in the first embodiment.

FIG. 2 is an exploded view illustrating a wrench's bolt head locator structure in the first embodiment.

FIG. 3 is a schematic view illustrating a wrench's bolt head locator structure in service in the first embodiment.

FIG. 4 is an exploded view illustrating a wrench's bolt head locator structure in the second embodiment.

FIG. 5 is a schematic view illustrating a wrench's bolt head locator structure in the third embodiment.

FIG. 6 is a schematic view illustrating a wrench's bolt head locator structure in the fourth embodiment.

FIG. 7 is a schematic view illustrating a wrench's bolt head locator structure installed in a box end wrench.

### DETAILED DESCRIPTION OF THE PREFERRED EMBODIMENTS

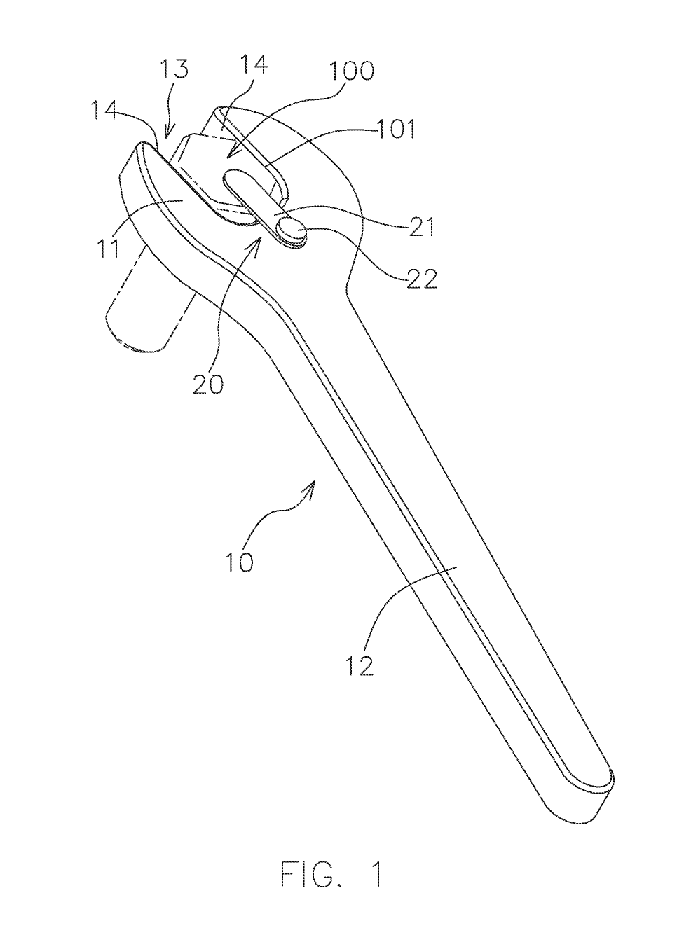

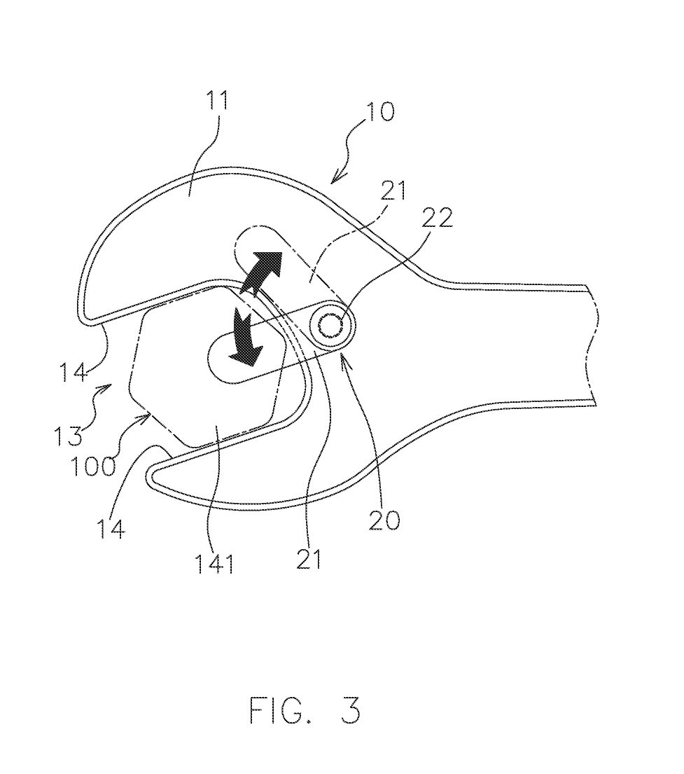

Please refer to FIGS. 1 and 3 which illustrate a wrench's bolt head locator structure in the first embodiment comprises a wrench 10 and an actuator device 20. The wrench 10 comprises a head part 11 and a shank part 12: the head part 11 has an accommodation space 13 that is an open space developed in an open spanner or an encompassed space or a specific-shaped space developed in an alternative wrench for accommodation of a bolt, a bolt head or another workpiece to be screwed (unscrewed) and is encircled by a plurality of conjunction planes 14, all of which can be flat planes, camber surfaces or curved surfaces or a mixture thereof; the head part 11 further has a mounting hole 15 which is behind the accommodation space 13 and near the shank part 12 or another proper part (location) on the head part 11 for installation of the actuator device 20; the shank part 12 is integrated with the head part 11 and in favor of force application on a wrench to be rotated clockwise or counterclockwise.

The actuator device 20 is installed at one lateral side of the wrench 10. In the embodiment, the actuator device 20 and the mounting hole 15 are designed on some positions include, without limitation, the head part 11 and the shank part 12 near the head part 11. The actuator device 20 comprises a locating piece 21 and a guide pin 22, the locating piece 21 that is a sheet body, for example, a sheet made of metal, magnetic metal or an alternative material, develops a pilot hole 211, which corresponds to the mounting hole 15 on the head part 11 and is penetrated by the guide pin 22, is securely fixed on the head part 11 of the wrench 10, and extends in the accommodation space 13. The locating piece 21 is irremovably or flexibly fixed on the head part 11 of the wrench 10 by the guide pin 22 which can be a rivet, a bolt, a pivot or another component via riveting, screw joint, pivoting or another method.

Moreover, the wrench 10 is further provided with a lighting device (not shown in figures), for example, LED lighting, which is installed on the head part 11 or the shank part 12 of the wrench 10 or on an inner wall beside the accommodation space 13 of the head part 11, in order to provide satisfactory illumination to the wrench 10 used in screwing (unscrewing) a bolt head (or another workpiece) held and fixed in the accommodation space.

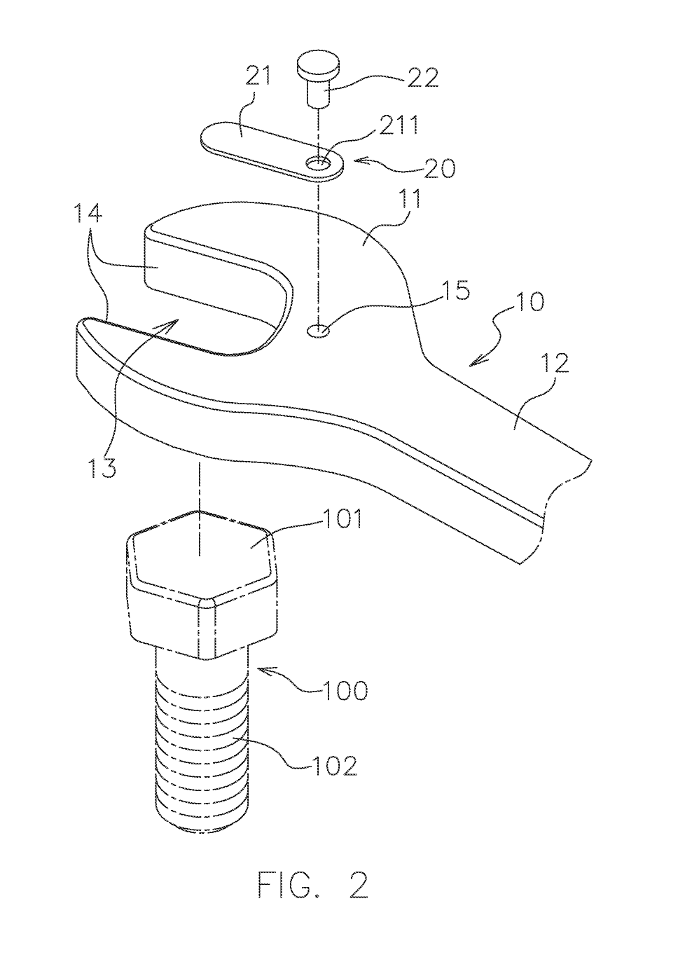

Please refer to FIGS. 2 and 3 which illustrate a bolt head 101 of a bolt 100 is held in the accommodation space 13 of the wrench 10 on which the locating piece 21 is flexibly installed and a bolt shank 102 of the bolt 100 is located under the accommodation space 13. The bolt head 101 contacting the conjunction planes 14 around the accommodation space 13 can be screwed or unscrewed when the locating piece 21 is turned and downward resists the bolt head 101 of the bolt 100 for more stability of the bolt head 101 held in the wrench 10. In the embodiment, malposition or separation attributed to the bolt head 101 upward moving and the head part 11 of the wrench 10 downward moving in the course of force application does not exist; the locating piece 21 can be further turned and deviated from the accommodation space 13 when a bolt head 101 is totally screwed (unscrewed) or the locating piece 21 is no use.

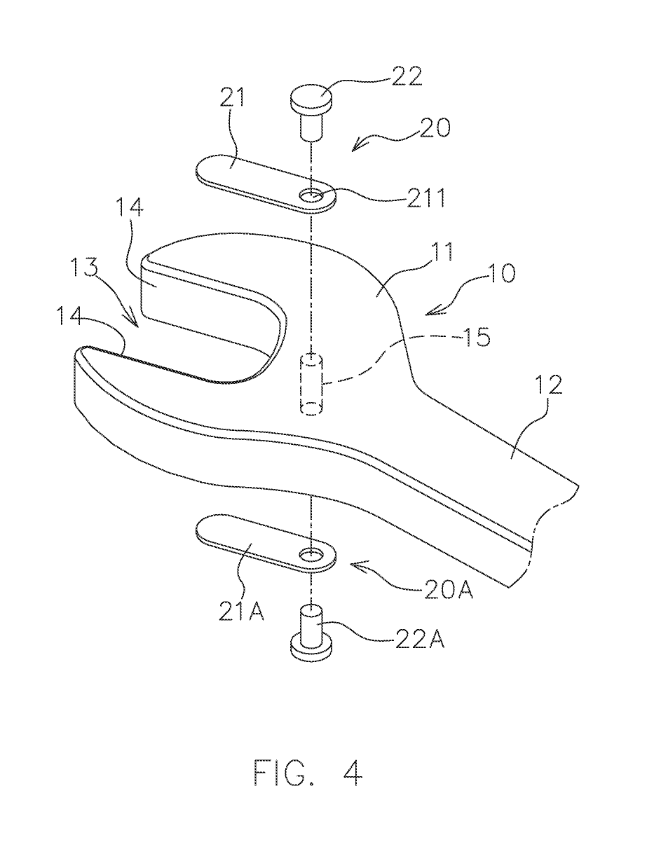

Please refer to FIG. 4 which illustrates a wrench's bolt head locator structure in the second embodiment based on the first embodiment but different from the first one as shown hereinafter. The head part 11 of the wrench 10 is provided with the actuator device 20 and the actuator device 20A at both lateral sides. That is, the locating piece 21 (locating piece 21A) and the guide pin 22 (guide pin 22A) are mounted together through the mounting hole 15 at one lateral side of the head part 11 by riveting, screw joint, pivoting or another method. As such, the wrench 10 depending on a workpiece to be screwed (unscrewed) or space for force application can be flexibly turned normally or reversely; the locating piece 21 over the bolt head 101 is screwed in and downward contacts the bolt head 101 of the bolt 100 for better stability of the wrench 10 dominating the bolt head 101. Moreover, the wrench's bolt head locator structure in favor of flexibly normal or reverse operation of the wrench 10 prevents the head part 11 of the wrench 10 and a workpiece (a bolt head) from malposition or separation.

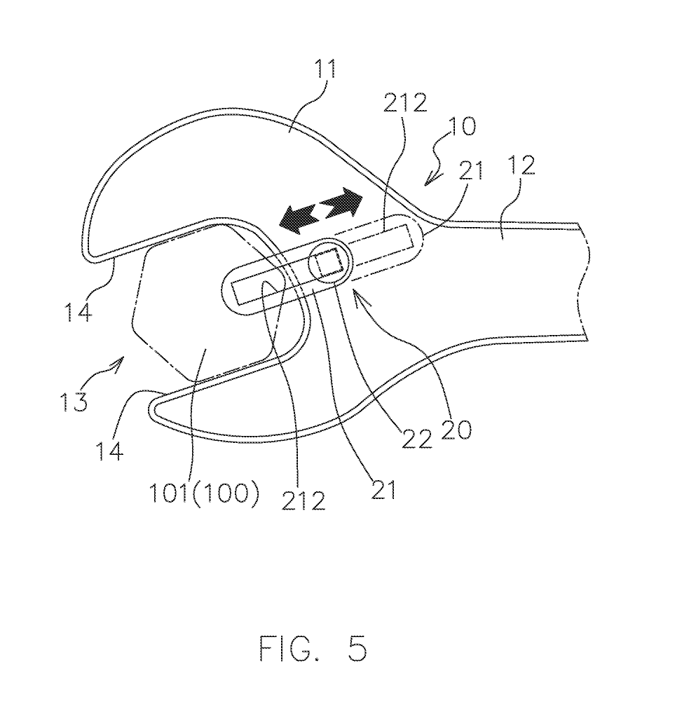

Please refer to FIG. 5 which illustrates a wrench's bolt head locator structure of the present disclosure in the third embodiment based on the first embodiment but different from the first one as shown hereinafter. A strip of actuation groove 212 opened on the locating piece 21 is prepared for the guide pin 22 to be held in the head part 11 of the wrench 10 via riveting, screw joint, pivoting or another method. As such, the locating piece 21 extends in or retreats from the accommodation space 13 via the actuation groove 212, that is, the extended locating piece 21 contacting the bolt head 101 of the bolt 100 reinforces stability of the wrench 10 dominating the bolt head 101 and prevents malposition or separation attributed to the bolt head 101 downward moving and the head part 11 of the wrench 10 upward moving when the wrench 10 allows the bolt 100 (the bolt head 101) to be held in the accommodation space 13.

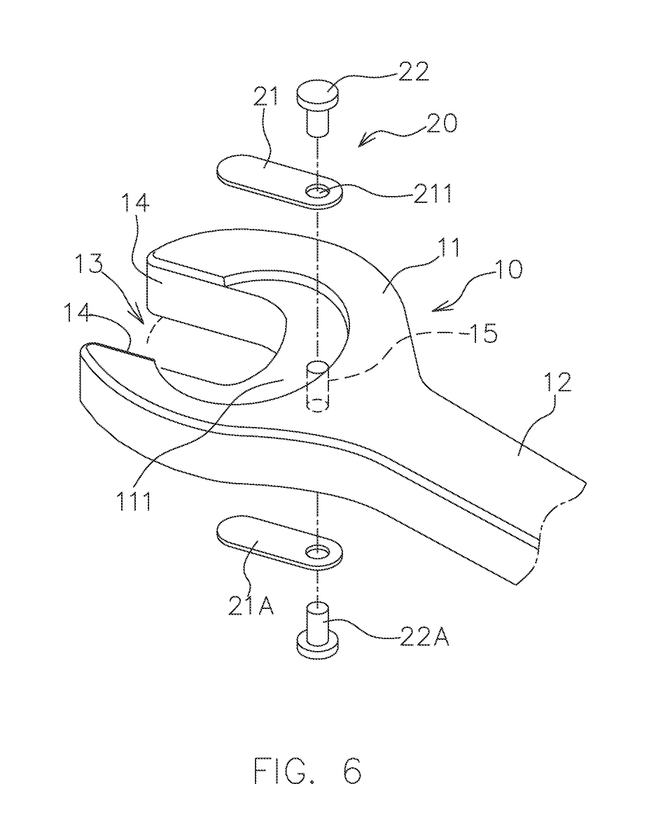

Please refer to FIG. 6 which illustrates a wrench's bolt head locator structure of the present disclosure in the fourth embodiment based on the second embodiment but different from the second one as shown hereinafter. Two recessed surfaces 111 deigned on the head part 11 and lower than both lateral sides of the head part 11 expand from the accommodation space 13, covering at least the locating piece 21 (21A) around which depends on the guide pin 22 (22A) to join the mounting hole 15 at the lateral side of the head part 11 via riveting, screw joint, pivoting or another method and allows its top to level with the lateral side of the head part 11. As such, the top of the locating piece 21 (21A) on the reverse side of the wrench 10, which is being normally operated (or reversely operated), approximately levels with the lateral side of the head part 11 so that a workpiece is turned more and tightly contacts an object to be fixed.

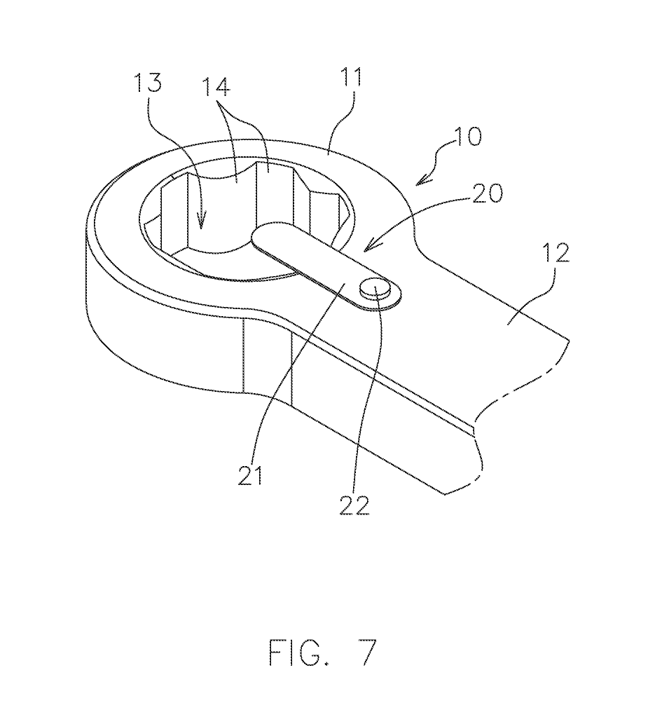

Please refer to FIG. 7 which illustrates the wrench 10 in the present disclosure can be an alternative model, for example, a box end wrench (FIG. 7), a combo wrench, an adjustable wrench, a socket wrench or others.

The present disclosure presents preferred embodiments hereinbefore. In further applications, the mounting hole 15 can be opened on the shank part 12 so that the actuator device 20 is fixed. In other words, the actuator device 20 can be situated at the head part 11 or the shank part 12 of the wrench 10.

As shown in the previous descriptions, a wrench's bolt head locator structure in the present disclosure relies on simple components and operation to securely fix a bolt head in a wrench, prevents malposition between the wrench and a bolt head, and realizes smooth, convenient and safe operation of the wrench. In addition, the conjunction planes between the wrench and a bolt head are properly illuminated for safe visual inspection in an operating area and promotional practicability and product competitiveness.

Accordingly, a wrench's bolt head locator structure in the present disclosure meets patentability. However, the above descriptions are preferred embodiments which do not limit the scope of the wrench's bolt head locator structure; any equivalent change or improvement in shapes, structure or features without departing from spirit of the present disclosure should be incorporated in claims herein.

What is claimed is:

1. A wrench's bolt head locator structure, comprising:
a wrench comprising a head part in which an accommodation space is developed and a shank part;
an actuator device comprising at least a sheet locating piece situated at said wrench and extending into said accommodation space.

2. A wrench's bolt head locator structure according to claim 1 wherein said accommodation space is an open space, an encompassed space, or another specific space.

3. A wrench's bolt head locator structure according to claim 1 wherein said locating piece is immovably or flexibly held in said wrench.

4. A wrench's bolt head locator structure according to claim 1 wherein said locating piece is fixed on said wrench via riveting, screw joint, pivoting or another method.

5. A wrench's bolt head locator structure according to claim 4 wherein said wrench is provided with said locating pieces at its both lateral sides.

6. A wrench's bolt head locator structure according to claim 1 wherein said accommodation space is encircled by a plurality of conjunction planes, all of which can be flat planes, camber surfaces or curved surfaces or a mixture thereof.

7. A wrench's bolt head locator structure according to claim 1 wherein said locating piece is metal sheet.

8. A wrench's bolt head locator structure according to claim 1 wherein said locating piece is a magnetic metal sheet.

9. A wrench's bolt head locator structure according to claim 1 wherein said locating piece has an actuation groove by which a guide pin can be held in said wrench via riveting, screw joint, pivoting or another method.

10. A wrench's bolt head locator structure according to claim 1 wherein said wrench is further provided with a lighting device which can be LED lighting at a proper location or around said accommodation space.

11. A wrench's bolt head locator structure according to claim 1 wherein said wrench comprises recessed surfaces which are located at and lower than lateral sides of said wrench for setup of said locating piece and expand from said accommodation space to cover at least said locating piece around.

12. A wrench's bolt head locator structure according to claim 1 wherein said locating piece can be situated at said head part.

13. A wrench's bolt head locator structure according to claim 1 wherein said locating piece can be situated at said shank part.
